(19) United States
(12) Patent Application Publication
(10) Pub. No.: US 2014/0179841 A1
(43) Pub. Date: Jun. 26, 2014

(54) Stabilized Polymer Composition Containing an Impact Modifier

(71) Applicant: Ticona LLC, Florence, KY (US)

(72) Inventors: Malvika Bihari, Florence, KY (US); Lowell Larson, Independance, KY (US)

(73) Assignee: Ticona LLC, Florence, KY (US)

(21) Appl. No.: 14/137,360

(22) Filed: Dec. 20, 2013

Related U.S. Application Data
(60) Provisional application No. 61/745,866, filed on Dec. 26, 2012.

(51) Int. Cl. C08K 5/50; C08K 5/057; C08K 5/357; C08K 5/3432; C08K 5/098

(52) U.S. Cl. CPC C08K 5/50; C08K 5/3432; C08K 5/098; C08K 5/357; C08K 5/057
USPC 524/97; 524/99; 524/398; 524/102; 524/327; 524/154

(57) ABSTRACT

An impact modified polyoxymethylene polymer composition is described containing a melt flow stabilizer. The polymer composition may contain a polyoxymethylene polymer containing functional groups, a thermoplastic elastomer and a coupling agent. A melt flow stabilizer is added to the composition in order to stabilize the melt volume flow rate of the composition after the components have been formulated. The melt flow stabilizer may comprise a pyridine derivative.

### BACKGROUND

Polyoxymethylene polymers are a group of high-performance polymers having good mechanical properties, such as rigidity and strength. Polyoxymethylene polymers are widely used as an engineering material in many different types of applications. For instance, polyoxymethylene polymers are used to produce automotive parts, components in the electronics field, and in medical technologies.

Polyoxymethylene polymers, however, have impact resistant properties that are too low for many applications. Thus, in the past, in order to improve impact resistance properties, impact modifiers have been blended with polyoxymethylene polymers. Impact modifiers comprise organic additives, such as crosslinked or non-crosslinked elastomers or graft copolymers made from an elastomeric core covered by a hard outer graft layer. Problems have been experienced in combining a polyoxymethylene polymer with an impact modifier since polyoxymethylene polymers have a relatively high polarity and crystallinity which makes them somewhat incompatible with other polymers.

In view of the above, various attempts have been made to increase the compatibility between an impact modifier and a polyoxymethylene polymer. For instance, U.S. Patent Publication No. 2009/0264583 to Kurz, which is incorporated herein by reference, discloses a molding material comprising a polyoxymethylene polymer and a thermoplastic elastomer. The polyoxymethylene polymer incorporated into the material is formulated such that at least 50% of the terminal groups are hydroxyl groups. The '583 publication also teaches the use of a coupling agent. The polymer composition disclosed in the '583 application has made great advances in the art producing moldings having relatively high impact strength resistance properties,

Unfortunately, however, polymer compositions containing a polyoxymethylene polymer, an impact modifier, and a coupling agent have a tendency to have a relatively unstable melt flow viscosity. After the components are blended together, for instance, the melt flow rate has a tendency to fluctuate for two to four weeks. Thus, after being formulated, the polymer composition typically requires an aging time of about four weeks prior to being used in a molding process.

In view of the above, a need currently exists for an impact modified polyoxymethylene polymer composition that has a stable melt flow rate. In particular, a need exists for an impact modified polyoxymethylene polymer composition that can be used almost immediately after the polymer composition has been formulated.

### SUMMARY

In general, the present disclosure is directed to a polymer composition containing a polyoxymethylene polymer and an impact modifier that not only has excellent impact resistance properties but also has a stable melt viscosity or flow rate. In accordance with the present disclosure, for instance, a melt flow stabilizer is added during blending of the different components to form the polymer composition. The melt flow stabilizer is added in an amount sufficient so that the melt flow rate of the resulting composition does not fluctuate over time, allowing for the polymer composition to be used immediately in molding processes after being produced.

For instance, in one embodiment, the present disclosure is directed to a polymer composition that comprises a polyoxymethylene polymer. The polyoxymethylene polymer may contain functional groups, such as terminal hydroxyl groups. The polymer composition also contains an impact modifier that may comprise a thermoplastic elastomer. The composition may contain a coupling agent that attaches the thermoplastic elastomer to the polyoxymethylene polymer. In accordance with the present disclosure, the polymer composition further contains a melt flow stabilizer that inhibits changes in melt flow rate over time after the polyoxymethylene polymer, the thermoplastic elastomer, and the coupling agent have been combined together.

In one embodiment, the melt flow stabilizer is present in the polymer composition in an amount sufficient such that the melt flow rate of the polymer composition 24 hours after the polymer composition is formulated (i.e. blended or mixed) does not vary by more than about 30%, such as by more than about 20%, such as by more than about 15%, such as more than about 10%, such as more than about 5% when compared to the melt flow rate of the composition, in one embodiment, after 14 days and, in another embodiment, after 7 days.

The melt flow stabilizer may comprise, in one embodiment, a pyridine derivative. In one embodiment, for instance, the melt flow stabilizer comprises dimethylamino pyridine. In another embodiment, the melt flow stabilizer comprises 4-morpholinopyridine. In still other embodiments, the melt flow stabilizer comprises 4-pyrrolidinopyridine, 2-phenylphenol sodium salt tetrahydrate, triphenyiphosphine, or mixtures thereof. Other melt flow stabilizers that may be used depending on the application include zinc stearate, triethanolamine, stannous octoate, zinc chelate, or mixtures thereof. The above melt flow stabilizers may be used alone or in combination.

The present disclosure is also directed to a process for catalyzing a chemical reaction between a polyoxymethylene polymer and an isocyanate. The process includes the step of reacting a polyoxymethylene polymer having functional groups with an isocyanate in the presence of a pyridine derivative. The pyridine derivative may have a 4-N-substituted pyridine ring. The pyridine derivative, in one embodiment, may comprise 4-morpholinopyridine. In one particular embodiment, the functional groups on the polyoxymethylene polymer may comprise hydroxyl groups while the isocyanate may comprise a diisocyanate.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a fuel tank made in accordance with the present disclosure;

FIG. 2 is a cross sectional view of the fuel tank illustrated in FIG. 1;

FIGS. 3 through 11 are graphical representations of the results obtained in Example No. 1 below; and

FIGS. 12 through 17 are graphical representations of the results obtained in Example No. 2 below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer composition containing a polyoxymethylene polymer and an impact modifier that has stabilized melt viscosity characteristics. For instance, polymer compositions made in accordance with the present disclosure not only have excellent impact resistance properties but also have a stable melt flow rate that does not fluctuate drastically once the polymer composition is formulated. In accordance with the present disclosure, a melt flow stabilizer is incorporated into the polymer composition that allows the polymer composition to be used immediately in molding processes after being formulated.

In the past, for instance, polyoxymethylene polymer compositions containing an impact modifier and a coupling agent typically exhibited a relatively unstable melt flow rate after the components were combined together. Consequently, in the past, the polymer compositions were formulated and then had to go through an aging process prior to use. In many instances, the polymer composition would need to have an aging time of greater than a week, and even greater than two weeks prior to use. The melt flow stabilizer of the present disclosure, on the other hand, can eliminate the above problem.

The polymer composition of the present disclosure generally contains a polyoxymethylene polymer containing functional groups. The functional groups, for instance, may comprise hydroxy end groups. The polymer composition further contains an impact modifier and a coupling agent. The impact modifier may comprise a thermoplastic elastomer. The coupling agent, on the other hand, may comprise, for instance, an isocyanate that attaches the thermoplastic elastomer to the functional groups, such as the hydroxy end groups. The use of a coupling agent in combination with a thermoplastic elastomer produces molded articles with very good impact resistant properties. The molded articles can also have excellent permeability properties,

In accordance with the present disclosure, the polymer composition further includes a melt flow stabilizer for stabilizing the melt flow characteristics of the polymer composition after the components have been melt blended together. In one embodiment, the melt flow stabilizer comprises a pyridine derivative, such as a pyridine derivative having a 4-N-substituted pyridine ring. For instance, the melt flow stabilizer may comprise dimethylamino pyridine, 4-pyrrolidinopyridine, 4-morpholinopyridine, or mixtures thereof.

In addition to a pyridine derivative, various other melt flow stabilizers may be used depending upon the particular application. For example, other melt flow stabilizers include 2-phenylphenol sodium salt tetrahydrate and triphenylphosphine. In one embodiment, a mixture of different melt flow stabilizers may be used. For instance, a pyridine derivative may be combined with other melt flow stabilizers. Selection of a particular melt flow stabilizer can depend upon various factors including the type of polyoxymethylene polymer present in the composition, the type of thermoplastic elastomer present and the type of coupling agent used. The selection of one or more melt flow stabilizers can also depend upon the relative amounts of the components.

Examples of other melt flow stabilizers that may be used include metal compounds, amines, phosphonium salts, ammonium salts, sulfonium salts, zirconates, and the like. In one embodiment, the melt flow stabilizer may comprise a zinc compound, a tin compound, a magnesium compound, an iron compound, a gallium compound, an aluminum compound, a titanium compound, a manganate compound, or the like. For instance, the compound may comprise a halogen salt, such as a bromine, a chlorine or a fluorine salt. The compound may also comprise a sulfate, or a carboxylate. Compounds which may be used include titanium tetrabutoxide, zirconium tetrabutoxide, tetrapentyl titanate, tetrapentyl zirconate, tetrahexyl titanate, tetraisobutyl titanate, tetraisobutyl zirconate, tetra-tert-butyl titanate, tetra-tert-butyl zirconate, triethyl tert-butyl titanate, triethyl tert-butyl zirconate, and similar compounds.

Particular examples of melt flow stabilizers that may be used further include zinc stearate, triethanolamine, stannous octoate, zinc chelate, and mixtures thereof.

As stated above, the above melt flow stabilizers may be combined with a pyridine derivative such as dimethylamino pyridine. Other pyridine derivatives that may be used include 4-morpholinopyridine, 4-diethylamino pyridine, 4-pyrolidinopyridine, 4-piperidinopyridine, or mixtures thereof.

Only relatively small amounts of the melt flow stabilizer need to be present in the polymer composition for the viscosity properties of the composition to be stabilized. For instance, the melt flow stabilizer can be present in the composition in an amount from about 0.001% to about 1% by weight, such as from about 0.05% to about 0.5% by weight, such as from about 0.05% to about 0.1% by weight.

The melt flow stabilizer is combined with a polyoxymethylene polymer, an impact modifier, and a coupling agent. The polyoxymethylene polymer, the coupling agent, the impact modifier, and the melt flow stabilizer may all be combined together at the same time. Alternatively, the melt flow stabilizer may be added at a later point in the process. For instance, the melt flow stabilizer may be added after the other three components have been compounded together and during molding into a particular product or shape.

The melt flow stabilizer serves to bring to completion any chemical reactions that take place within the composition, such as between the functional groups on the polyoxymethylene polymer and the isocyanate coupling agent. In this regard, the present disclosure is also directed to a process for catalyzing a chemical reaction between a polyoxymethylene polymer containing functional groups and an isocyanate compound. The process includes the step of reacting the polyoxymethylene polymer with the isocyanate compound in the presence of a pyridine derivative, namely 4-morpholinopyridine.

In one embodiment, a polyoxymethylene polymer is used that chemically reacts or attaches to the impact modifier. The polyoxymethylene polymer, for instance, may include functional groups, such as hydroxyl groups. In one embodiment, a coupling agent may be present in the composition that couples the impact modifier to the polyoxymethylene polymer. More particularly, the coupling agent may react with first reactive groups on the polyoxymethylene polymer and with second reactive groups present on the impact modifier. In one embodiment, for instance, the coupling agent may comprise an isocyanate that chemically attaches the impact modifier to the polyoxymethylene polymer.

The polyoxymethylene polymer used in the polymer composition may comprise a homopolymer or a copolymer. The polyoxymethylene polymer, however, generally contains a relatively high amount of reactive groups, such as hydroxyl groups in the terminal positions. More particularly, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 5 mmol/kg, such as at least 10 mmol/kg, such as at least 15 mmol/kg. In one embodiment, the terminal hydroxyl group content ranges from 18 to 500 mmol/kg, such as from about 50 mmol/kg to about 400 mmol/kg. In one particular embodiment, for instance, the terminal hydroxyl group content may be from about 100 mmol/kg to about 400 mmol/kg.

In addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

In addition to having a relatively high terminal hydroxyl group content, the polyoxymethylene polymer according to the present disclosure can also optionally have a relatively low amount of low molecular weight constituents. As used herein, low molecular weight constituents (or fractions) refer to constituents having molecular weights below 10,000 dalton. In this regard, the polyoxymethylene polymer contains low molecular weight constituents in an amount less than about 10% by weight, based on the total weight of the polyoxymethylene. In certain embodiments, for instance, the polyoxymethylene polymer may contain low molecular weight constituents in an amount less than about 5% by weight, such as in an amount less than about 3% by weight, such as even in an amount less than about 2% by weight.

The preparation of the polyoxymethylene can be carried out by polymerization of polyoxymethylene-forming monomers, such as trioxane or a mixture of trioxane and dioxolane, in the presence of ethylene glycol as a molecular weight regulator. The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted. The above-described procedure for the polymerization can lead to polymers having comparatively small proportions of low molecular weight constituents. If a further reduction in the content of low molecular weight constituents were to be desired, this can be effected by separating off the low molecular weight fractions of the polymer after the deactivation and the degradation of the unstable fractions after treatment with a basic protic solvent. This may be a fractional precipitation from a solution of the stabilized polymer; polymer fractions of different molecular weight distribution being obtained.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2% by weight.

A heteropoly acid refers to polyacids formed by the condensation of different kinds of oxo acids through dehydration and contains a mono- or polynuclear complex ion wherein a hetero element is present in the center and the oxo acid residues are condensed through oxygen atoms. Such a heteropoly acid is represented by the formula:

Hₓ[MₘM′ₙO_{z}]yH₂O

wherein
M represents an element selected from the group consisting of P, Si, Ge, Sn, As, Sb, U, Mn, Re, Cu, Ni, Ti, Co, Fe, Cr, Th or Ce,
M′ represents an element selected from the group consisting of W, Mo, V or Nb,
   m is 1 to 10,
   n is 6 to 40,
   z is 10 to 100,
   x is an integer of 1 or above, and
   y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof.

Excellent results have been achieved with heteropoly acids selected from 12-molybdophosphoric acid (H₃PMo₁₂O₄₀) and 12-tungstophosphoric acid (H₃PW₁₂O₄₀) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfils the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

(ROOC)—(CH₂)ₙ₋(COOR′)

wherein
n is an integer from 2 to 12, preferably 3 to 6 and
R and R′ represent independently from each other an alkyl group having 1 to 4 carbon atoms, preferably selected from the group consisting of methyl, ethyl, n-propyl, iso-propyl, n-butyl, iso-butyl and tert.-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

(ROOC)₂—CH—(CH₂)ₘ—CH—(COOR′)₂

wherein
m is an integer from 0 to 10, preferably from 2 to 4 and
R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butantetracarboxylic acid tetratethyl ester or butantetracarboxylic acid tetramethyl ester.

Preferably, the heteropoly acid is dissolved in the alkyl ester of the polybasic carboxylic acid in an amount lower than 5 weight percent, preferably in an amount ranging from 0.01 to 5 weight percent, wherein the weight is based on the entire solution.

In some embodiments, the polymer composition of the present disclosure may contain other polyoxymethylene homopolymers and/or polyoxymethylene copolymers. Such polymers, for instance, are generally unbranched linear polymers which contain as a rule at least 80%, such as at least 90%, oxymethylene units. Such conventional polyoxymethylenes may be present in the composition while still maintaining sufficient functional groups, such as hydroxyl terminated groups.

The polyoxymethylene polymer present in the composition can generally have a melt volume rate (MVR) or melt index of less than 50 cm³/10 min, such as from about 1 to about 40 cm³/10 min, determined according to ISO 1133 at 190° C. and 2.16 kg. In general, the molecular weight of the polyoxymethylene polymer is related to the melt index. In particular, a higher melt index refers to a lower molecular weight. In one embodiment of the present disclosure, a polyoxymethylene polymer is incorporated into the polymer composition having a relatively low molecular weight. The amount of coupling agent, however, is increased based upon the molecular weight and the number of terminal hydroxyl groups. It has been discovered that lowering the molecular weight of the polymer while increasing the amount of coupling agent produces a polymer composition capable of being blow molded and that has significantly improved multi axial impact properties, especially when measured at extremely low temperatures.

For example, in one embodiment, the present disclosure is directed to a polyoxymethylene polymer having an increased number of hydroxyl terminal groups and that has a melt index of from about 5 cm³/10 min to about 20 cm 10 min, such as from about 7 cm³/10 min to about 12 cm³/10 min, such as from about 8 cm³/10 min to about 10 cm³/10 min. In this embodiment, the polyoxymethylene polymer may optionally have lower amounts of low molecular weight constituents.

The amount of polyoxymethylene polymer present in the polymer composition of the present disclosure can vary depending upon the particular application. In one embodiment, for instance, the composition contains polyoxymethylene polymer in an amount of at least 50% by weight, such as in an amount greater than about 60% by weight, such as in an amount greater than about 65% by weight, such as in an amount greater than about 70% by weight. In general, the polyoxymethylene polymer is present in an amount less than about 95% by weight, such as in an amount less than about 90% by weight, such as in an amount less than about 85% by weight.

As described above, in addition to a polyoxymethylene polymer, the composition also contains an impact modifier and a coupling agent if needed for an attachment to occur. The impact modifier may comprise a thermoplastic elastomer. In general, any suitable thermoplastic elastomer may be used according to the present disclosure as long as the thermoplastic elastomer can attach to the polyoxymethylene polymer whether through the use of a coupling agent or otherwise. In one embodiment, for instance, the thermoplastic elastomer may include reactive groups that directly or indirectly attach to reactive groups contained on the polyoxymethylene polymer. For instance, in one particular embodiment, the thermoplastic elastomer has active hydrogen atoms which allow for covalent bonds to form with the hydroxyl groups on the polyoxymethylene using the coupling agent.

Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE-E), thermoplastic polyamide elastomers (TPE-A) and in particular thermoplastic polyurethane elastomers (TPE-U). The above thermoplastic elastomers have active hydrogen atoms which can be reacted with the coupling reagents and/or the polyoxymethylene polymer. Examples of such groups are urethane groups, amino groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic polyurethane elastomer is used as the impact modifier either alone or in combination with other impact modifiers. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(c-caprolactone)diol; and polyether dials such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis(cycloxylisocyanate). Suitable chain extenders are C₂-C₆ aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

The amount of impact modifier contained in the polymer composition used to form the containment device can vary depending on many factors. The amount of impact modifier present in the composition may depend, for instance, on the desired permeability of the resulting material and/or on the amount of coupling agent present and the amount of terminal hydroxyl groups present on the polyoxymethylene polymer. In general, one or more impact modifiers may be present in the composition in an amount greater than about 5% by weight, such as in an amount greater than about 10% by weight. The impact modifier is generally present in an amount less than 30% by weight, such as in an amount less than about 25% by weight, such as in an amount up to about 18% by weight in order to provide sufficient impact strength resistance while preserving the permeability properties of the material.

The coupling agent present in the polymer composition comprises a coupling agent capable of coupling the impact modifier to the polyoxymethylene polymer. In order to form bridging groups between the polyoxymethylene polymer and the impact modifier, a wide range of polyfunctional, such as trifunctional or bifunctional coupling agents, may be used. The coupling agent may be capable of forming covalent bonds with the terminal hydroxyl groups on the polyoxymethylene polymer and with active hydrogen atoms on the impact modifier. In this manner, the impact modifier becomes coupled to the polyoxymethylene through covalent bonds.

In one embodiment, the coupling agent comprises a diisocyanate, such as an aliphatic, cycloaliphatic and/or aromatic diisocyanate. The coupling agent may be in the form of an oligomer, such as a turner or a dimer.

In one embodiment, the coupling agent comprises a diisocyanate or a triisocyanate which is selected from 2,2′-, 2,4′-, and 4,4′-diphenylmethane diisocyanate (MDI); 3,3′-dimethyl-4,4′-biphenylene diisocyanate (TODI; toluene diisocyanate (TDI); polymeric MDI; carbodiimide-modified liquid 4,4′-diphenylmethane diisocyanate; para-phenylene diisocyanate (PPDI); metaphenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis (isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic diisocyanate is used, such as 4,4′-diphenylmethane diisocyanate (MDI).

The polymer composition generally contains the coupling agent in an amount from about 0.1% to about 10% by weight. In one embodiment, for instance, the coupling agent is present in an amount greater than about 1% by weight, such as in an amount greater than 2% by weight. In one particular embodiment, the coupling agent is present in an amount from about 0.2% to about 5% by weight. To ensure that the impact modifier has been completely coupled to the polyoxymethylene polymer, in one embodiment, the coupling agent can be added to the polymer composition in molar excess amounts when comparing the reactive groups on the coupling agent with the amount of terminal hydroxyl groups on the polyoxymethylene polymer.

As described above, in one embodiment, greater amounts of the coupling agent are combined with the polyoxymethylene polymer when the polyoxymethylene polymer has a relatively low molecular weight. For instance, in one embodiment, the polyoxymethylene polymer can have a melt index of greater than about 5 cm³/10 min, such as greater than about 7 cm³/10 min. For instance, the polyoxymethylene polymer can have a melt index of from about 5 cm³/10 min to about 20 cm³/10 min, such as from about 7 cm³/10 min to about 12 cm³/10 min, such as from about 8 cm³/10 min to about 10 cm³/10 min. In this embodiment, the coupling agent may be added in an amount such that there is from about 0.8 to about 2 mol of the coupling agent per mol of hydroxyl groups on the polyoxymethylene polymer. For instance, in one embodiment, the coupling agent can be added in an amount greater than 1.5% by weight, such as in an amount greater than about 3% by weight, such as from about 1.5% by weight to about 10% by weight, such as from about 1.5% by weight to about 5% by weight.

Combining a relatively low molecular weight polyoxymethylene polymer with greater amounts of coupling agent may produce hollow articles having increased multi axial impact strengths, especially at relatively low temperatures. For instance, the polymer composition may have a multi axial impact strength when tested according to ASTM D3763 and when measured at −40° C. of greater than about 15 ftlb-f, such as greater than about 18 ftlb-f, such as greater than about 20 ftlb-f. In general, the impact strength will be less than about 50 ftlb-f. Articles produced from the composition can thus pass SAE Test J288.

In one embodiment, a relatively low molecular weight polyoxymethylene polymer may be used and sufficient amounts of coupling agent may be combined with the polymer in conjunction with an impact modifier so as to produce a polymer composition that not only has excellent multi axial impact strength characteristics, but also is capable of being used in a blow molding process. In this regard, in one embodiment, the coupling agent can be added to the polymer composition in an amount sufficient for the polymer composition to have a shear viscosity of at least about 8000 Pa-s at a shear rate of 0.1 rad/sec and at a temperature of 190° C. For instance, the coupling agent may be added such that the polymer composition has a shear viscosity of from about 8000 Pa-s at the above conditions to about 30,000 Pa-s, such as from about 8000 Pa-s to about 15,000 Pa-s, such as from about 8000 Pa-s to about 12,000 Pa-s.

Adding copious amounts of the coupling agent into the polymer composition can, in some embodiments, further cause variability in the melt flow rate of the composition after the composition is produced. Of particular advantage, the melt flow stabilizer of the present disclosure can counteract this effect. Thus, greater amounts of coupling agent can be used to provide various benefits without the adverse consequences experienced in the past.

In one embodiment, a formaldehyde scavenger may also be included in the composition. The formaldehyde scavenger, for instance, may be amine-based and may be present in an amount less than about 1% by weight.

The polymer composition of the present disclosure can optionally contain a stabilizer and/or various other known additives. Such additives can include, for example, antioxidants, acid scavengers, UV stabilizers or heat stabilizers. In addition, the molding material or the molding may contain processing auxiliaries, for example adhesion promoters, lubricants, nucleating agents, demolding agents, fillers, reinforcing materials or antistatic agents and additives which impart a desired property to the molding material or to the molding, such as dyes and/or pigments.

In general, other additives can be present in the polymer composition in an amount up to about 10% by weight, such as from about 0.1% to about 5% by weight, such as from about 0.1 to about 2% by weight.

When forming containment devices in accordance with the present disclosure, the above described components can be melt blended together, which automatically causes the reaction to occur between the coupling agent, the polyoxymethylene polymer, and the impact modifier. As described above, the coupling agent reacts with the reactive end groups on the polyoxymethylene polymer and the reactive groups on the impact modifier. The reaction between the components can occur simultaneously or in sequential steps. In one particular embodiment, the components in the composition are mixed together and then melt blended in an extruder.

The reaction of the components is typically effected at temperatures of from 100 to 240° C., such as from 150 to 220° C., and the duration of mixing is typically from 0.5 to 60 minutes.

In one embodiment, the molding composition of the present disclosure is reacted together and compounded prior to being used in a molding process. For instance, in one embodiment, the different components can be melted and mixed together in a conventional single or twin screw extruder at a temperature described above. Extruded strands may be produced by the extruder which are then pelletized. Prior to compounding, the polymer components may be dried to a moisture content of about 0.05 weight percent or less. If desired, the pelletized compound can be ground to any suitable particle size, such as in the range of from about 100 microns to about 500 microns.

One of the primary advantages of the present disclosure is that the molding composition can be used almost immediately after the above components are reacted together and compounded. The melt flow stabilizer inhibits changes in melt flow over time after the components are mixed and combined together.

Polymer compositions made according to the present disclosure can be used to make all different types of molded articles. For instance, the polymer composition can be used to produce automotive parts, industrial parts, consumer appliance parts, and the like. Particular products include, for instance, clips for fixing cable harnesses on the interior of automobiles, fixing holders or rails for interior components, such as airbags and loud speakers, boat release buttons or caps, and the like. Shaped articles according to the present disclosure can further include components incorporated into window wipers.

Due to the excellent permeability properties of the composition, the composition can also be used to produce fuel tanks. In particular, any type of VOC or compressed gas containment device may be made in accordance with the present disclosure. As used herein, a “containment device” refers to any hollow article that is designed to contain or in any way come in contact with VOCs and/or compressed gases. In addition to tanks, for instance, a containment device may comprise a tube, a hose, or any other similar device. The containment device, for instance, may be designed to contact or contain hydrocarbon fluids, pesticides, herbacides, brake fluid, paint thinners, and various compressed hydrocarbon gases, such as natural gas, propane, and the like. When used as a fuel tank, the containment device may contact or contain any suitable hydrocarbon fluid, whether liquid or gas.

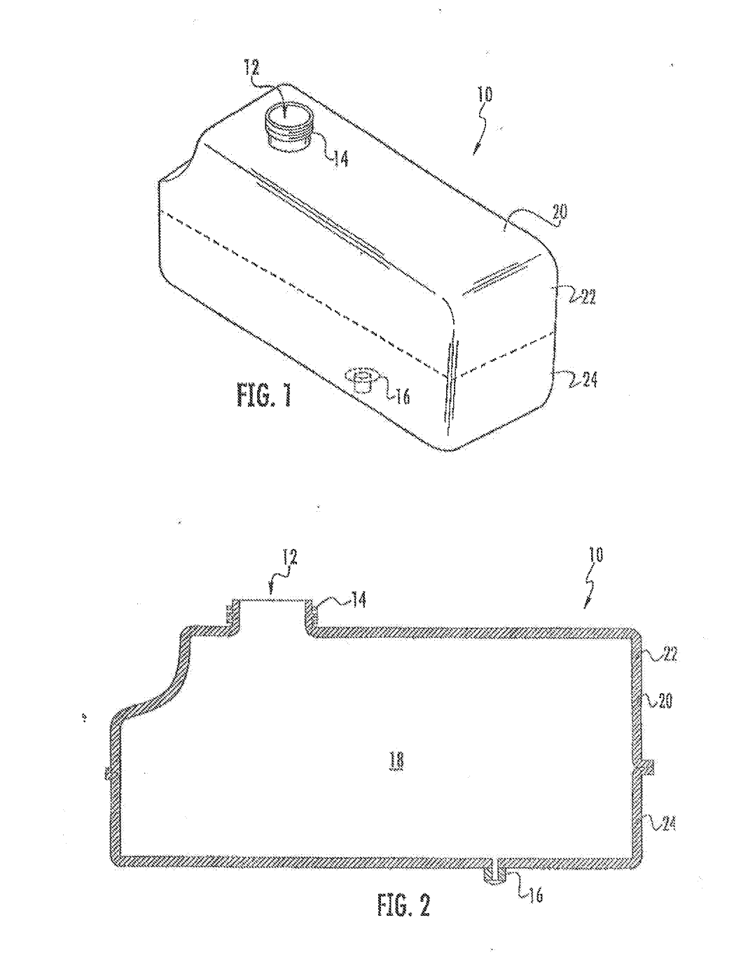

Referring to FIGS. 1 and 2, for instance, one embodiment of a fuel tank 10 that may be made in accordance with the present disclosure is shown. The fuel tank 10 includes an opening or inlet 12 for receiving a fuel. The opening 12 can be defined by a threaded fixture 14. The threaded fixture 14 is adapted for receiving a fuel and for receiving a cap (not shown). A cap can be placed over the threaded fixture 14, for instance, in order to prevent fuel and vapors from leaving the fuel tank 10.

The fuel tank 10 further includes at least one outlet 16 for feeding a fuel to a combustion device, such as an engine.

The fuel tank 10 defines a container volume 18 for receiving a fuel. The container volume 18 is surrounded by a container wall 20. The container wall 20 can include multiple sides. For instance, the container wall can include a top panel, a bottom panel, and four side panels. Alternatively, the fuel tank 10 can have a spherical shape, a cylindrical shape, or any other suitable shape.

The present disclosure may be better understood with reference to the following examples.

### EXAMPLES

The following experiments were conducted in order to show some of the benefits and advantages of compositions made according to the present disclosure.

### Example Nos. 1-6

Various impact modified polyoxymethylene polymer compositions were formulated. Some of the compositions contained a melt flow stabilizer in accordance with the present disclosure.

In the examples below, the polyoxymethylene composition contained a thermoplastic polyurethane elastomer (TPU) in an amount of about 18% by weight. The composition also contained 4,4′-diphenylmethane diisocyanate (MDI) in an amount of either 0.5% by weight or 2% by weight. In addition to a stabilizer package containing an antioxidant and a lubricant, the composition further contained a polyoxymethylene (POM) polymer that contained a significant amount of hydroxyl terminal groups. Specifically, at least 80% of the end groups of the polyoxymethylene polymer were hydroxyl groups. The antioxidant used was a sterically hindered phenolic antioxidant. The lubricant used was N,N′ethylenebisstearamide.

The above components were blended together alone in some embodiments and in other embodiments with a melt flow stabilizer in accordance with the present disclosure. The melt flow stabilizer comprised dimethylamino pyridine (DMAP) or zinc stearate. The melt flow stabilizer was added to the composition in an amount of about 0.05% by weight.

The following compositions were formulated.

TABLE 1

| | Ex. 1 | Ex. 2 | Ex. 3 | Ex. 4 | Ex. 5 | Ex. 6 |
|---|---|---|---|---|---|---|
| Component | (wt %) | (wt %) | (wt %) | (wt %) | (wt %) | (wt %) |
| POM Polymer | 81.1 | 83.05 | 79.6 | 79.55 | 81.1 | 81.05 |
| Antioxidant | 0.25 | 0.25 | 0.25 | 0.25 | 0.25 | 0.25 |
| Lubricant | 0.15 | 0.15 | 0.15 | 0.15 | 0.15 | 0.15 |
| TPU | 18 | 18 | 18 | 18 | 18 | 18 |
| MDI | 0.5 | 0.5 | 2 | 2 | 0.5 | 0.5 |
| DMAP | 0 | 0.05 | 0 | 0.05 | 0 | 0 |
| Zinc Stearate | 0 | 0 | 0 | 0 | 0 | 0.05 |

The melt volume flow rate was determined according to ISO Test 1133 at 190° C. and at a load of 2.16 kg.

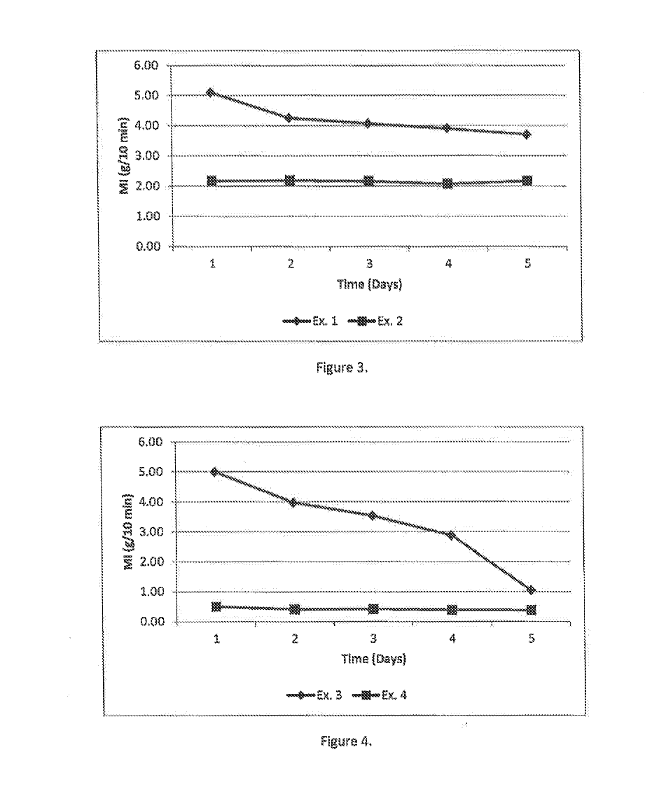

The melt index or melt flow rate was measured over time for Example No. 1 and Example No. 2, and Example Nos. 3 and 4. The results are shown in FIGS. 3 and 4. As shown, the melt flow rate for Example No. 1 and 3 were unstable especially over the first five days and continued to decrease thereafter. The melt flow rate of Example Nos. 2 & 4 made in accordance with the present disclosure did not fluctuate more than 5%, and not even more than 2% over the five day period. The melt index for Example Nos. 2 and 4 was equal to the final melt index of the examples without the flow enhancer. The melt flow stabilizer is believed to increase reaction rates between the components thus stabilizing the melt index.

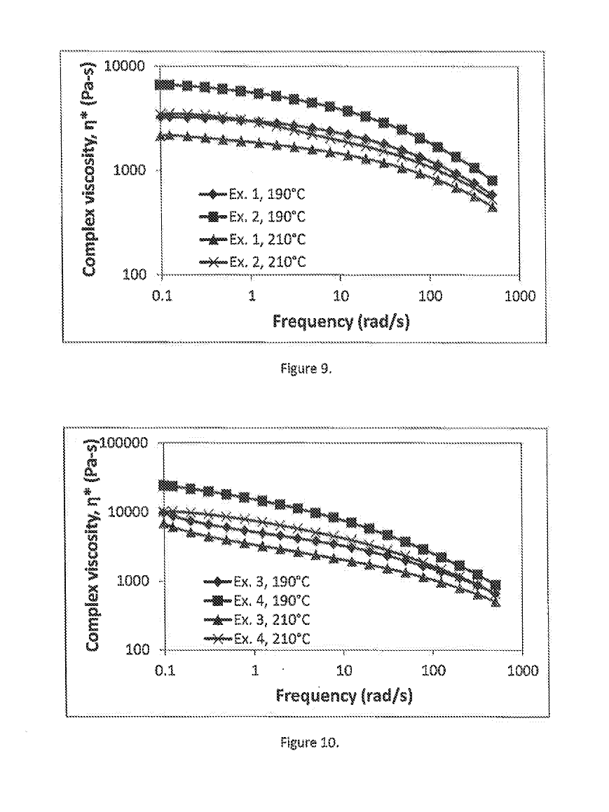

The complex viscosity of the compositions was also tested. Complex viscosity was tested at different frequencies and at different temperatures. The complex viscosity results are illustrated in FIGS. 9 and 10. As illustrated, the formulations containing the melt flow stabilizer had a higher initial viscosity at temperatures of 190° C. and at temperatures of 210° C.

The tensile modulus and the Charpy notched impact strength of Example Nos. 1 through 4 was also tested. Tensile modulus was tested according to ISO Test 527-1/-2. Charpy notched impact strength was tested at 23° C. and at −30° C. according to ISO Test 179/1 eA.

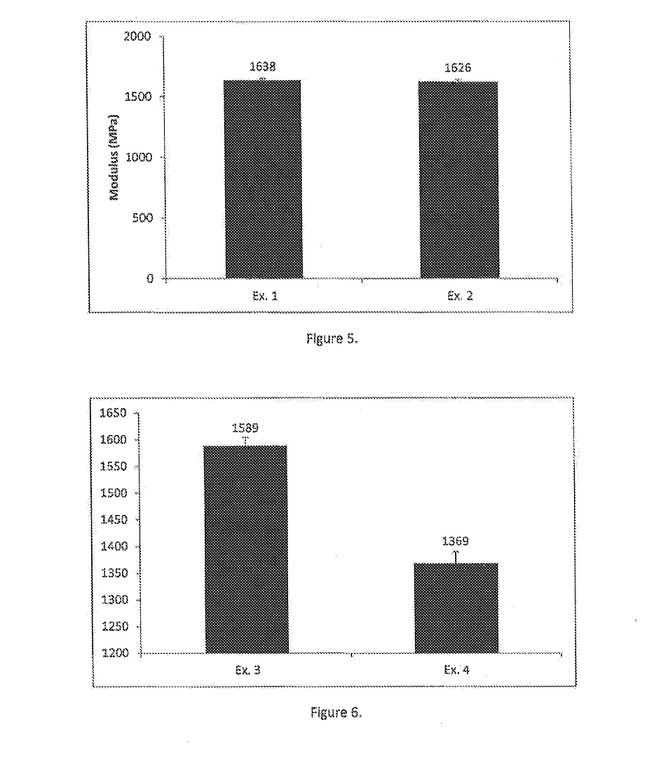

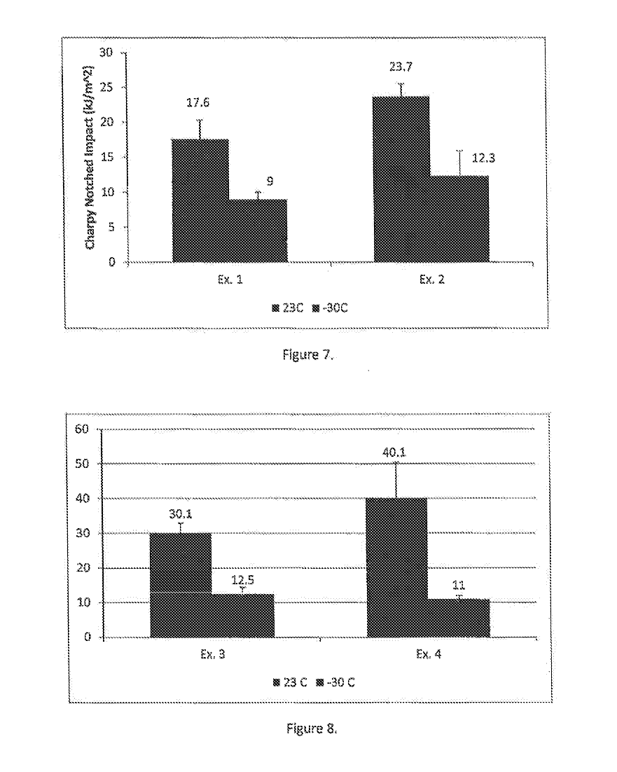

The results are illustrated in FIGS. 5-8. As shown in the figures, the melt flow stabilizer reduced the modulus slightly and improved the impact strength of the finished product, especially for the samples with the higher amount of coupling agent.

Further polymer compositions were formulated as shown in the table above. Example No, 5 contained generally the same components in the same amounts as Example No. 1. Example No. 6 was substantially identical to Example No. 2 except that the melt flow stabilizer used was zinc stearate. The two compositions were then tested for melt volume flow rate over time. The results are shown in FIG. 11. As shown, the melt volume flow rate of Example No. 6 containing zinc stearate did not fluctuate by more than 10% over the first five days, over the first 14 days, or even over the entire 61 day period.

### Example Nos. 7-10

In the following examples, different melt flow stabilizers were tested. In particular, two pyridine derivatives were tested that include a 4-N-substituted pyridine ring. Specifically, the melt flow stabilizer used in Example No. 7 was 4-morpholinopyridine (MPP) and the melt flow stabilizer examined in Example No. 8 was 4-pyrrolidinopyridine (PPY). Two other melt flow stabilizers were also tested. In particular, in Example No. 9, 2-phenylphenol sodium salt tetrahydrate (SOPP) was tested, while in Example No. 10 triphenylphosphine (TPP) was tested. The above melt flow stabilizers have the following chemical structure:

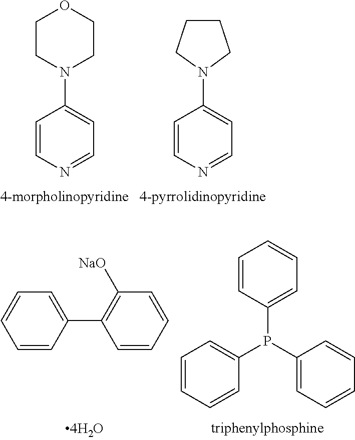

Of particular advantage, 4-morpholinopyridine, 2-phenylphenol sodium salt tetrahydrate, and triphenylphosphine have relatively low health risk ratings.

The above melt flow stabilizers were combined with essentially the same composition described in Example Nos. 1-6 above. In particular, the composition contained 16% or 18% by weight of the thermoplastic polyurethane elastomer, 2% by weight of the coupling agent (MDI) and the remainder was a polyoxymethylene polymer similar to the polyoxymethylene polymer described in Example Nos. 1-6 where at least 80% of the end groups of the polymer were hydroxyl groups.

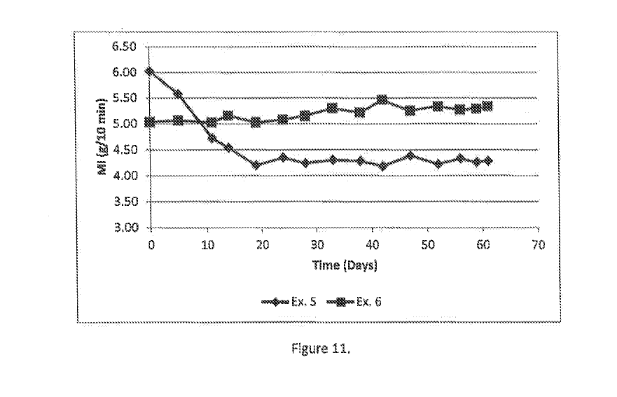

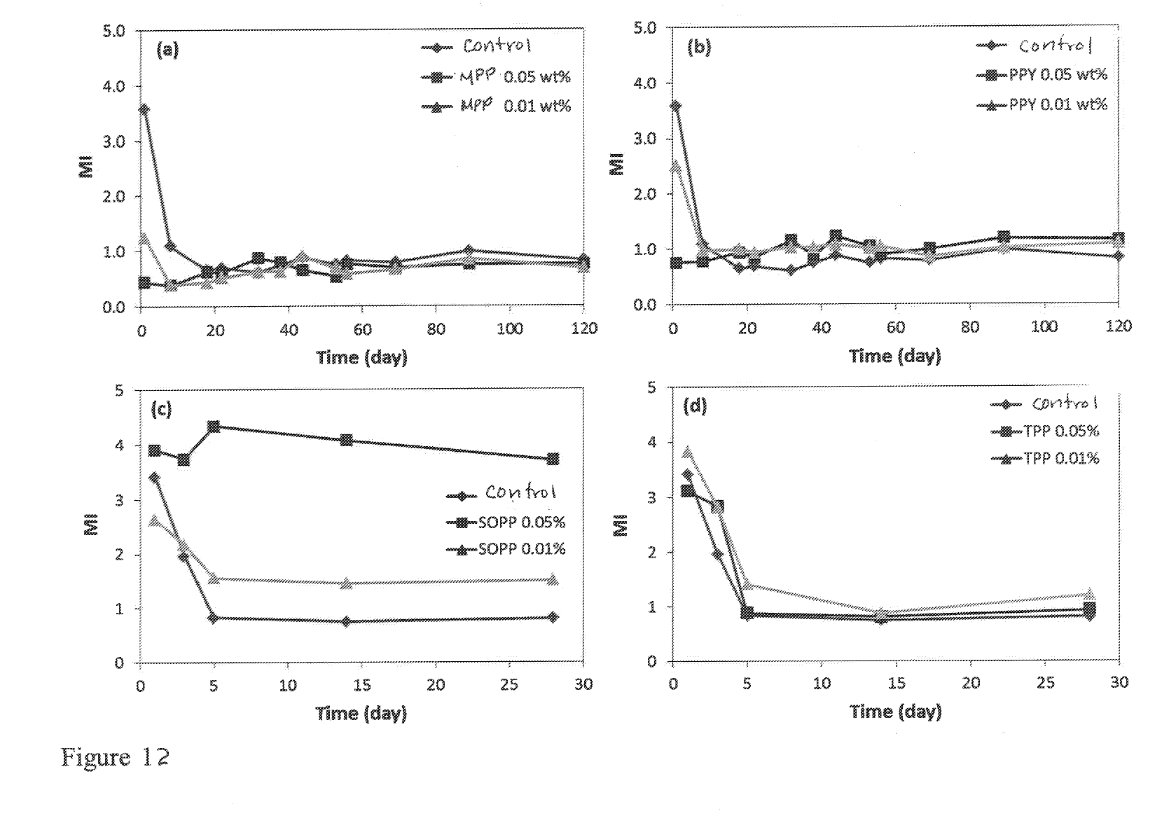

The above components and each melt flow stabilizer was compounded together using an 18 mm co-rotating twin-screw extruder. FIG. 12 shows the effect of the four melt flow stabilizers on the melt volume flow rate or melt index (MI) after extrusion when the composition contained 18% by weight of the thermoplastic polyurethane elastomer.

As shown in FIG. 12(a), the 4-morpholinopyridine (MPP) significantly lowered the melt index after extrusion in comparison to the control. When 4-morpholinopyridine was present at 0.01% by weight, the melt index stabilized after 7 days. In contrast, the control sample required 17 days to reach a stable melt index. When the composition contained 0.05% 4-morpholinopyridine, the melt index reached the lowest stable level right after extrusion. Of particular advantage, the compositions containing 4-morpholinopyridine reached a final stable melt index that was the same as the control sample.

Example No. 8 contained pyrrolidinopyridine (PPY). As shown in FIG. 12(b), after 7 days, the composition containing 0.01% by weight PPY stabilized. When PPY was present in an amount of 0.05% by weight, the melt index stabilized immediately after extrusion.

2-phenylphenol sodium salt tetrahydrate also helped stabilize the melt index of the composition, especially when present at 0.01% by weight.

Further tests were conducted using 4-morpholinopyridine as a melt flow stabilizer. In the further tests, a 32 mm co-rotating twin-screw extruder was used to compound the components.

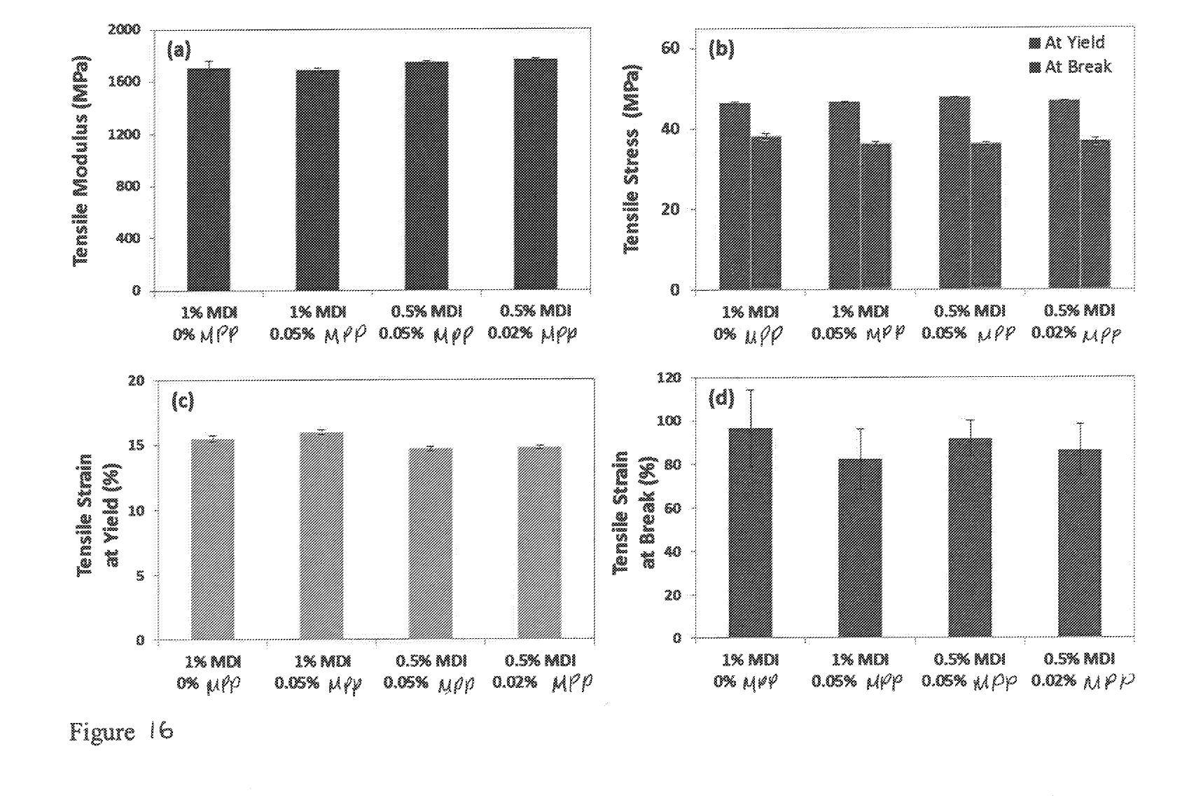

FIG. 15 shows the melt index of polyoxymethylene polymer compositions containing 16% by weight of the thermoplastic polyurethane elastomer and containing different levels of the coupling agent in combination with different levels of 4-morpholinopyridine. As shown, the melt index of all samples containing MPP stabilized immediately after extrusion. In contrast, the sample containing no melt flow stabilizer took 20 days to stabilize. Varying the amount of the coupling agent can have an impact upon the final melt index of the composition. This indicates that the coupling agent reaction level is determined by the concentration of the coupling agent and that the addition of the melt flow stabilizer does not lower the final melt index.

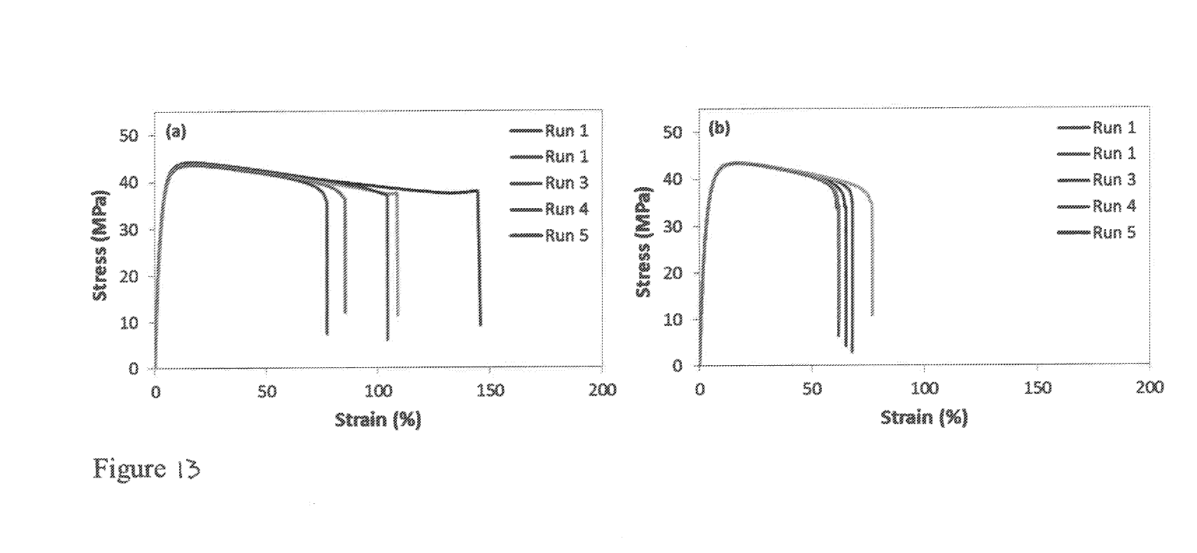

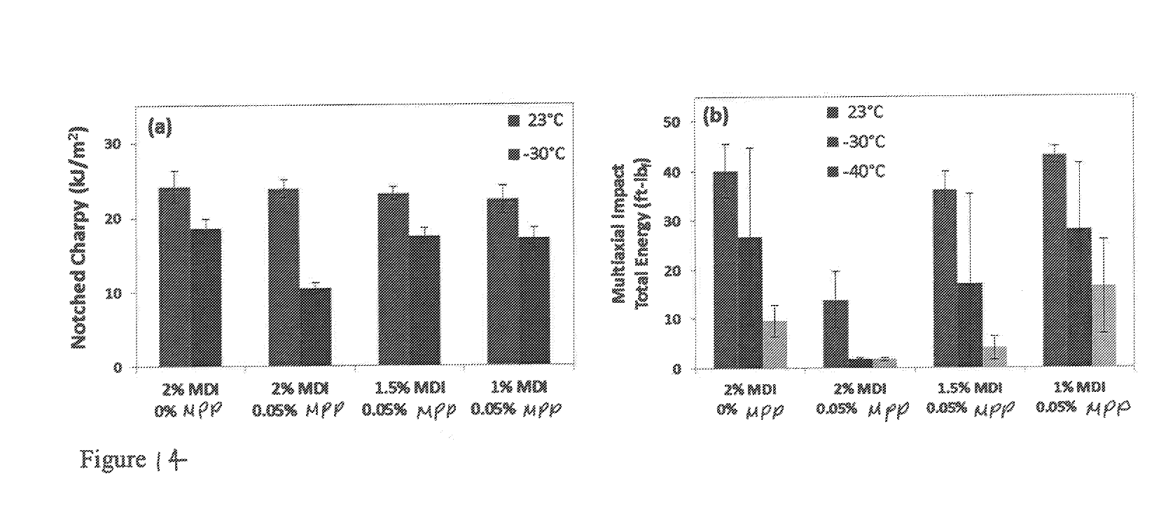

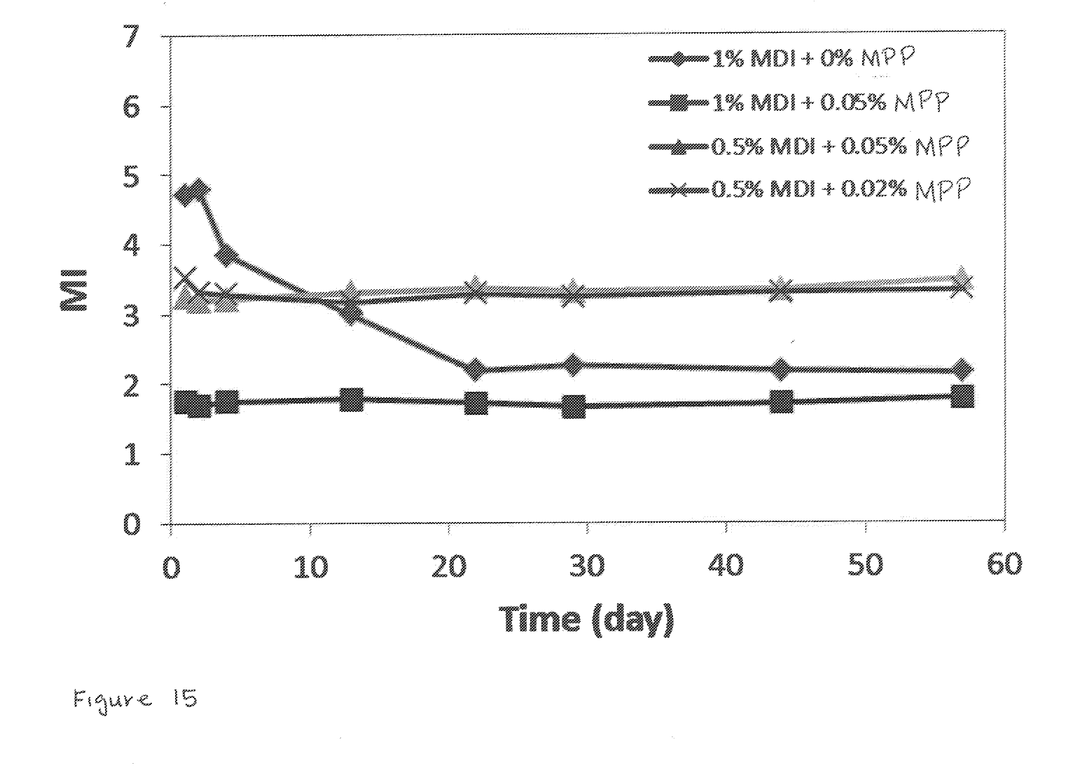

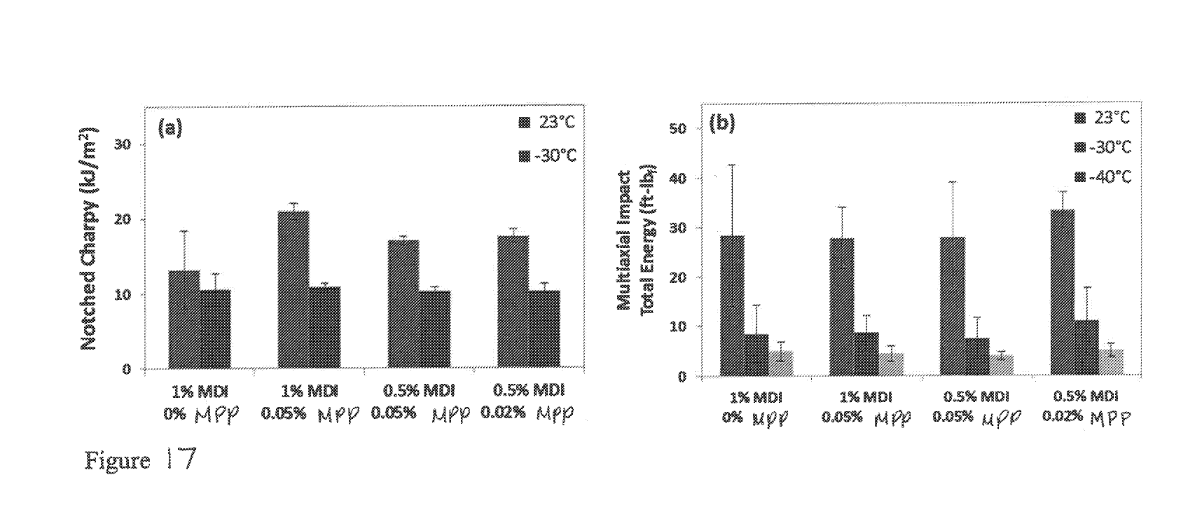

Next, the mechanical properties of compositions containing 4-morpholinopyridine were tested. The same tensile tests described in Example Nos. 1-6 were used. In FIGS. 13 and 14, the compositions contained 18% by weight of the thermoplastic polyurethane elastomer. In FIGS. 16 and 17, on the other hand, the compositions contained the thermoplastic polyurethane elastomer in an amount of 16% by weight.

The molding of the test specimens was done 16 days after compounding in order to ensure that the melt index of all samples had stabilized. The pellets were dried prior to molding. Overall, the tensile properties did not change significantly at different loading levels of the coupling agent.

As shown in FIG. 16, as the amount of coupling agent added to the composition decreased, the multiaxial impact strength increased.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a polyoxymethylene polymer containing functional groups;
a thermoplastic elastomer;
a coupling agent that attaches the thermoplastic elastomer to the polyoxymethylene polymer; and
a melt flow stabilizer that inhibits changes in melt flow over time after the polyoxymethylene polymer, the thermoplastic elastomer, and the coupling agent have been combined together, the melt flow stabilizer being present in the polymer composition in an amount sufficient such that the melt flow rate of the polymer composition when tested at 190° C. and at a load of 2.16 kg does not vary by more than about 30% when comparing the melt flow rate 24 hours after the polyoxymethylene polymer, the thermoplastic elastomer and the coupling agent have been combined to the melt flow rate after 5 days.

2. A polymer composition as defined in claim 1, wherein the melt flow stabilizer comprises a pyridine derivative.

3. A polymer composition as defined in claim 1, wherein the melt flow stabilizer comprises a pyridine derivative having a 4-N-substituted pyridine ring.

4. A polymer composition as defined in claim 1, wherein the melt flow stabilizer comprises 4-morpholinopyridine.

5. A polymer composition as defined in claim 1, wherein the melt flow stabilizer comprises 4-pyrrolidinopyridine.

6. A polymer composition as defined in claim 1, wherein the melt flow stabilizer comprises 2-phenylphenol sodium salt tetrahydrate.

7. A polymer composition as defined in claim 1, wherein the melt flow stabilizer comprises dimethylamino pyridine.

8. A polymer composition as defined in claim 1, wherein the melt flow stabilizer comprises zinc stearate, triethanolamine, stannous octoate, zinc chelate, dimethylamino pyridine, or mixtures thereof.

9. A polymer composition as defined in claim 1, wherein the melt flow stabilizer is present in the composition in an amount from about 0.001% to about 1% by weight.

10. A polymer composition as defined in claim 1, wherein the functional groups attached to the polyoxymethylene polymer comprise hydroxyl end groups.

11. A polymer composition as defined in claim 10, wherein the polyoxymethylene polymer includes terminal groups and wherein at least more than about 50% of the terminal groups are hydroxyl groups.

12. A polymer composition as defined in claim 1, wherein the polyoxymethylene polymer comprises a copolymer and wherein the functional groups comprise hydroxyl groups, the hydroxyl groups comprising hydroxyethylene groups.

13. A polymer composition as defined in claim 1, wherein the thermoplastic elastomer comprises a thermoplastic polyurethane elastomer.

14. A polymer composition as defined in claim 1, wherein the thermoplastic elastomer is present in the polymer composition in an amount from about 2% to about 40% by weight.

15. A polymer composition as defined in claim 1, wherein the coupling agent comprises an isocyanate.

16. A polymer composition as defined in claim 1, wherein the coupling agent is present in the polymer composition in an amount from about 0.1% to about 3% by weight.

17. A polymer composition as defined in claim 1, wherein the polymer composition has a melt flow rate at 190° C. and at a load of 2.16 kg of from about 0.25 g/10 min to about 20 g/10 min.

18. A polymer composition as defined in claim 1, wherein the melt flow rate of the polymer composition does not vary by more than 20% when comparing the melt flow rate 24 hours after the composition has been formulated to the melt flow rate after five days.

19. A polymer composition as defined in claim 1, wherein the melt flow rate of the polymer composition does not vary by more than 15% when comparing the melt flow rate 24 hours after the composition has been formulated to the melt flow rate after 5 days.

20. A molded article made from the polymer composition defined in claim

21. A molded article as defined in claim 20, wherein the molded article comprises a fuel tank.

22. A molded article as defined in claim 20, wherein the molded article comprises an automotive part, a consumer appliance part, or an industrial part.

23. A polymer composition as defined in claim 1, wherein the melt flow stabilizer is present in the composition in an amount less than about 0.5% by weight.

24. A process for catalyzing a chemical reaction between functional groups on a polyoxymethylene polymer and an isocyanate, the process comprising reacting the polyoxymethylene polymer with the isocyanate in the presence of a pyridine derivative.

25. A process as defined in claim 24, wherein the pyridine derivative has a 4-N-substituted pyridine ring.

26. A process as defined in claim 24, wherein the pyridine derivative comprises 4-morpholinopyridine.

27. A process as defined in claim 24, wherein the functional groups on the polyoxymethylene polymer comprise hydroxyl groups.
